(19) United States
(12) Patent Application Publication
(10) Pub. No.: US 2024/0399469 A1
(43) Pub. Date: Dec. 5, 2024

(54) Drill Bit Cutter and Drill Bit

(71) Applicant: Robert Bosch GmbH, Stuttgart (DE)

(72) Inventors: Haifeng Ji, Hangzhou, Zhejiang (CN); Massimo Anghileri, Zuchwil, Solothurn (CH); Andrea Pedretti, Zuchwil, Solothurn (CH)

(21) Appl. No.: 18/701,222

(22) PCT Filed: Oct. 13, 2022
(86) PCT No.: PCT/EP2022/078502

§ 371 Date: Apr. 13, 2024

(30) Foreign Application Priority Data
Oct. 15, 2021 (CN) 2021 2249 3393.2

(51) Int. Cl. B23B 51/00

(52) U.S. Cl. CPC B23B 51/0002; B23B 2251/04; B23B 2251/14

(57) ABSTRACT

A drill bit cutter and a drill bit are disclosed. The drill bit cutter defines a rotation axis and includes two cutter parts located at two sides of the rotation axis in a transverse direction, each cutter part having a front cutter face, a rear cutter face, and a blade formed between the front cutter face and the rear cutter face. The front cutter face of each cutter part is ground to form a ground shaped face. The ground shaped faces of the two front cutter faces are different, At least a local height difference is thereby produced in the two blades. Drilling precision can be increased while extending cutter life.

### TECHNICAL FIELD

The present application relates to a drill bit cutter and a drill bit using such a cutter, which are especially suitable for drilling hard materials.

### BACKGROUND ART

At present, most drill bits have symmetric drill bit cutters. When the drill bit cutter drills into a workpiece, each blade sustains pressure from the workpiece. Because the two blades are symmetric, they both contact the workpiece along their entire length, and a large contact area is maintained between the workpiece and the two blades. It has now been discovered that the drilling speed of a drill bit is related to the contact pressure between the blade and the workpiece; the larger the contact area between the blade and the workpiece, the smaller the pressure between them, and this will cause the drilling speed to fall. To increase the pressure between the blade and the workpiece so as to increase the drilling speed, it is possible to consider reducing the cutter thickness or increasing the blade sharpness, but this will increase the rate at which the cutter is worn away.

### SUMMARY OF THE INVENTION

The present application is intended to provide a drill bit cutter and a drill bit using such a drill bit cutter, which are capable of increasing drilling precision while extending cutter life.

According to one aspect of the present application, a drill bit cutter is provided, defining a rotation axis and comprising two cutter parts located at two sides of the rotation axis in a transverse direction, each cutter part having a front cutter face, a rear cutter face, and a blade formed between the front cutter face and the rear cutter face, wherein the front cutter face of each cutter part is ground to form a ground shaped face, the ground shaped faces of the two front cutter faces are different, and at least a local height difference is thereby produced in the two blades.

In an embodiment, grinding of one of the two cutter parts at the blade does not reach the rotation axis, and grinding of the other one at the blade reaches the rotation axis or goes beyond the rotation axis.

In an embodiment, grinding depths of the ground shaped faces of the two front cutter faces are the same or different.

In an embodiment, grinding depths of the ground shaped faces of the two front cutter faces are different.

In an embodiment, grinding of one of the two cutter parts at the blade does not reach the rotation axis, and grinding of the other one at the blade reaches the rotation axis or goes beyond the rotation axis.

In an embodiment, grinding of both cutter parts at the blade does not reach the rotation axis.

In an embodiment, grinding of both cutter parts at the blade reaches the rotation axis or goes beyond the rotation axis.

In an embodiment, each of the two ground shaped faces begins at a corresponding transverse edge of the drill bit cutter in the transverse direction.

In an embodiment, one of the two ground shaped faces begins at a corresponding transverse edge of the drill bit cutter in the transverse direction, and the other one begins at a position between the transverse centre and a corresponding transverse edge of the drill bit cutter in the transverse direction.

In an embodiment, each of the two ground shaped faces begins at a position between the transverse centre and a corresponding transverse edge of the drill bit cutter in the transverse direction.

In an embodiment, the two ground shaped faces are configured such that the two blades each have an effective cutting portion that participates in drilling of a workpiece material and a non-cutting portion that does not participate in drilling of the workpiece material.

In an embodiment, one of the two blades has an effective cutting portion that participates in drilling of the workpiece material and a non-cutting portion that does not participate in drilling of the workpiece material, and the entirety of the other one is an effective cutting portion.

In an embodiment, the two rear cutter faces are inclined at different angles relative to the transverse direction.

In an embodiment, a drill tip of the drill bit cutter deviates from the rotation axis in the transverse direction.

In an embodiment, the bisector of the angle between the two blades is inclined by an angle relative to the rotation axis.

According to another aspect of the present application, a drill bit is provided, comprising: the drill bit cutter as described above, mounted on a drill shank.

According to the present application, the two front cutter faces of the drill bit cutter have different ground shaped faces. During drilling, at least one blade only partially contacts the workpiece. Thus, the actual contact area between the blade and the workpiece is reduced, the pressure can increase, and the drilling speed can correspondingly increase.

### BRIEF DESCRIPTION OF THE FIGURES

A more comprehensive understanding of the abovementioned and other aspects of the present application can be gained from the detailed description below with reference to the following drawings, in which:

FIG. 1 is a front view of a drill bit according to an embodiment of the present application.

FIG. 2 is a rear view of the drill bit in FIG. 1.

FIG. 3 is a top view of the cutter of the drill bit in FIG. 1.

FIG. 4 is a side view of the cutter of the drill bit in FIG. 1.

FIGS. 5 and 6 are views of some other feasible embodiments of the cutter of the present application.

### DETAILED DESCRIPTION OF EMBODIMENTS

Various feasible embodiments of the drill bit and drill bit cutter according to the present application are described below with reference to the drawings. It must be pointed out that the drawings here are intended to clearly illustrate the principles of the present application, so certain details have been omitted, and the drawings are not drawn to scale or according to actual shape.

The present application relates generally to a drill bit and a drill bit cutter, which are capable of drilling materials of various hardnesses. The drill bit and drill bit cutter of the present application are especially suitable for drilling hard materials such as ceramic, stone, metal, hardwood, etc.

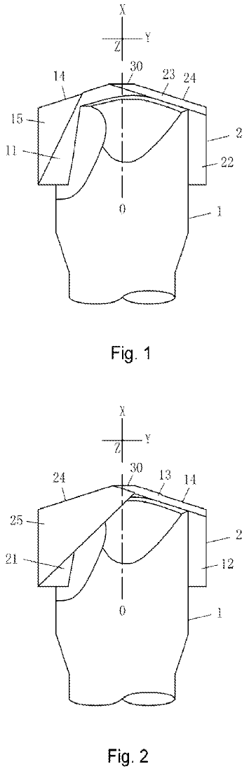

A drill bit according to an embodiment of the present application is shown in FIGS. 1 and 2, wherein FIG. 1 shows a first face of the drill bit and FIG. 2 shows an opposite second face of the drill bit.

As shown in the figures, the drill bit comprises a drill shank 1, and a drill bit cutter (hereinafter abbreviated as cutter) 2 clamped by an extremity of the drill shank 1. The cutter 2 is made of a hard alloy, and is substantially in the form of a flat plate, welded to the drill shank 1.

The cutter 2 has a height direction (axial direction) X, a width direction (transverse direction) Y and a thickness direction Z, which are respectively abbreviated as the X direction, Y direction and Z direction below. A rotation axis O of the cutter 2 lies in the X direction.

The cutter 2 comprises two symmetrical cutter parts. A first cutter part has a front cutter face 11 and a back face 12 opposite each other, a rear cutter face 13 located between the front cutter face 11 and the back face 12, and a blade 14 located between the front cutter face 11 and the rear cutter face 13, with an acute angle between the rear cutter face 13 and the front cutter face 11. A second cutter part has a front cutter face 21 and a back face 22 opposite each other, a rear cutter face 23 located between the front cutter face 21 and the back face 22, and a blade 24 located between the front cutter face 21 and the rear cutter face 23, with an acute angle between the rear cutter face 23 and the front cutter face 21. The blade 14 and blade 24 are linked by a transverse blade 30.

The rear cutter faces 13, 23 are inclined at the same angle relative to the Y direction.

In addition, part of the front cutter face 11 is ground to produce a ground shaped face 15; the ground shaped face 15 extends to the blade 14, such that part of the blade 14 is ground. The ground shaped face 15 does not reach the rotation axis O.

Part of the front cutter face 21 is ground to produce a ground shaped face 25; the ground shaped face 25 extends to the blade 24, such that the entirety of the blade 24 is ground. To give the ground shaped face 25 a certain degree of depth below the blade 24 in the X direction, the ground shaped face 15 crosses the rotation axis O and extends into the first cutter part by a small amount.

It must be pointed out that the ground shaped faces 15, 25 shown in FIGS. 1 and 2 both begin at the bottom of the cutter, and extend to the blades 14, 24. However, it is also possible to form the ground shaped faces 15, 25 by grinding in a region close to the blades 14, 24.

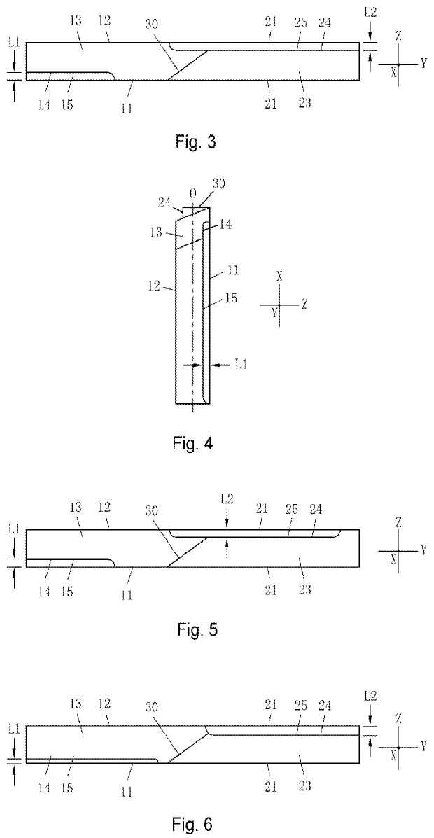

See FIGS. 3 and 4, which show a top view in the X direction and a side view in the Y direction of the cutter 2 in FIGS. 1 and 2. It must be pointed out that the grinding depths are shown schematically in the figures for clarity, and the actual grinding depths might be very different from those shown in the figures.

The ground shaped face 15 has a grinding depth L1, and the ground shaped face 15 has a grinding depth L2. L1 may be equal to L2 or not equal to L2.

It must be pointed out that if the ground shaped face is parallel to the original front cutter face before grinding, then the grinding depth may be defined as the perpendicular distance between the ground shaped face and the blade before grinding. If the ground shaped face is inclined relative to the original front cutter face, then the grinding depth may be defined as the distance between the blade (or part of the blade) after grinding and the blade before grinding.

In addition, it can be seen from FIG. 3 that the transverse blade 30 is inclined relative to the Z direction. However, in some cutters 2, the transverse blade 30 lies in the Z direction.

In addition, it can be seen from FIG. 4 that the rear cutter face 13 (and also the rear cutter face 23) is inclined relative to the Z direction. However, in some cutters 2, the rear cutter faces 13, 23 may be parallel to the Z direction.

In the embodiment described above, the ground shaped face of one of the two front cutter faces does not reach the rotation axis O in the Y direction at the blade, while the ground shaped face of the other one reaches the rotation axis O or is even ground beyond the rotation axis O in the Y direction at the blade; consequently, the two blades form an asymmetric structure (there is at least a local height difference between the blades at the two sides). Thus, in a drilling operation, the actual total contact area between the workpiece and the two blades is reduced, the pressure can increase, and the drilling speed can increase correspondingly.

Next, some additional or alternative solutions are described for the cutter 2.

The ground shaped faces 15, 25 shown in FIG. 3 both begin at transverse edges of the cutter 2 in the Y direction. However, one or both of the ground shaped faces 15, 25 may begin at a position between the transverse centre and a transverse edge of the cutter 2 in the Y direction.

For example, in the example shown in FIG. 5, the ground shaped face 15 begins at a left-side transverse edge of the cutter 2 in the Y direction, while the ground shaped face 25 does not begin at a right-side transverse edge of the cutter 2 in the Y direction, instead beginning at a position that is separated from the right-side transverse edge by a certain distance.

It is preferred that one of the ground shaped faces at the two sides does not begin at the transverse edge at the corresponding side in the Y direction, while the other begins at the transverse edge at the corresponding side. However, it is also possible for neither of the ground shaped faces at the two sides to begin at the transverse edge at the corresponding side in the Y direction.

In addition, in the example shown in FIG. 5, one of the ground shaped faces at the two sides may not reach the rotation axis O in the Y direction at the blade, while the ground shaped face of the other one reaches the rotation axis O or is even ground beyond the rotation axis O at the blade; or neither of the ground shaped faces at the two sides reaches the rotation axis O in the Y direction at the blade; or the ground shaped faces at the two sides both reach the rotation axis O or are even ground beyond the rotation axis O in the Y direction at the blade.

In addition, in the example shown in FIG. 5, the grinding depths L1, L2 of the ground shaped faces at the two sides may be equal or not equal.

The embodiment shown in FIG. 5 can likewise produce an asymmetric structure (with at least a local height difference between the blades at the two sides) at the two blades, and thus can achieve the technical effects that can be achieved by the embodiment described above with reference to FIGS. 1-4.

Another example of the cutter 2 is shown in FIG. 6, wherein the grinding depth L1 of the ground shaped face 15 is not equal to the grinding depth L2 of the ground shaped face 15.

In the example shown in FIG. 6, one of the ground shaped faces at the two sides may not reach the rotation axis O in the Y direction at the blade, while the ground shaped face of the other one reaches the rotation axis O or is even ground beyond the rotation axis O at the blade; or neither of the ground shaped faces at the two sides reaches the rotation axis O in the Y direction at the blade; or the ground shaped faces at the two sides both reach the rotation axis O or are even ground beyond the rotation axis O in the Y direction at the blade.

In addition, in the example shown in FIG. 6, one or both of the ground shaped faces at the two sides may not begin at the transverse edge of the cutter 2 in the Y direction, instead beginning at a position between the transverse centre and a transverse edge of the cutter 2.

The embodiment shown in FIG. 6 can likewise produce an asymmetric structure (with at least a local height difference between the blades at the two sides) at the two blades, and thus can achieve the technical effects that can be achieved by the embodiment described above with reference to FIGS. 1-4 and FIG. 5.

In general, the relevant features in the various embodiments of the cutter described above may be separate or combined with each other.

The two blades 14, 24 may each have an effective cutting portion that participates in drilling of the workpiece material, and a non-cutting portion that does not participate in drilling of the workpiece material. Alternatively, one of the two blades 14, 24 has an effective cutting portion that participates in drilling of the workpiece material and a non-cutting portion that does not participate in drilling of the workpiece material, while the entirety of the other one is an effective cutting portion.

Other optional features of the cutter 2 of the present application include: the rear cutter faces 13, 23 are inclined at different angles relative to the Y direction;
a drill tip of the cutter 2 (defined by the centre point of the transverse blade 30 before grinding) deviates from the rotation axis of the cutter in the Y direction;
the bisector of the angle between the two blades is inclined by an angle relative to the rotation axis of the cutter.

These features may be applied in various embodiments of the cutter described above, either alone or in combination with each other.

According to the present application, an asymmetric structure (with at least a local height difference between the blades at the two sides) is produced at the two blades by asymmetric grinding. Thus, in a drilling operation, at least one cutter participates in cutting of the workpiece only locally, the actual total contact area between the workpiece and the two blades is reduced, the total pressure of the reaction of the workpiece against the two blades can increase, and the drilling speed can increase.

In addition, both of the blades contact the workpiece (even though one or both of them contacts the workpiece locally), and the workpiece applies pressure to the cutter at two sides of the rotation axis; the transverse components of these two pressures can at least partially cancel each other out, and both blades sustain wear, so the rates of wear of the two blades are more balanced. These factors enable the service life of the drill bit cutter to be extended. Moreover, in the drilling process, the radial (transverse) components of the pressures sustained by the two blades from the material can cancel each other out to a certain extent, and it is thus possible to avoid dislocation of the drill bit due to a transverse pushing force of the material; this increases the drilling precision.

Although the present application has been described here with reference to specific exemplary embodiments, the scope of the present application is not limited to the details shown. Various amendments can be made to these details without deviating from the basic principles of the present application.

1. A drill bit cutter defining a rotation axis, comprising:
two cutter parts located at two sides of the rotation axis in a transverse direction, each cutter part having a front cutter face, a rear cutter face, and a blade formed between the front cutter face and the rear cutter face,
wherein the front cutter face of each cutter part is ground to form a ground shaped face,
wherein the ground shaped faces of the two front cutter faces are different, and
wherein at least a local height difference is thereby produced in the two blades.

2. The drill bit cutter according to claim 1, wherein grinding of one of the two cutter parts at the blade does not reach the rotation axis, and grinding of the other one at the blade reaches the rotation axis or goes beyond the rotation axis.

3. The drill bit cutter according to claim 2, wherein grinding depths of the ground shaped faces of the two front cutter faces are the same or different.

4. The drill bit cutter according to claim 1, wherein grinding depths of the ground shaped faces of the two front cutter faces are different.

5. The drill bit cutter according to claim 4, wherein grinding of one of the two cutter parts at the blade does not reach the rotation axis, and grinding of the other one at the blade reaches the rotation axis or goes beyond the rotation axis; or
grinding of both cutter parts at the blade does not reach the rotation axis; or
grinding of both cutter parts at the blade reaches the rotation axis or goes beyond the rotation axis.

6. The drill bit cutter according to claim 1, wherein each of the two ground shaped faces begins at a corresponding transverse edge of the drill bit cutter in the transverse direction.

7. The drill bit cutter according to claim 1, wherein one of the two ground shaped faces begins at a corresponding transverse edge of the drill bit cutter in the transverse direction, and the other one begins at a position between the transverse center and a corresponding transverse edge of the drill bit cutter in the transverse direction.

8. The drill bit cutter according to claim 1, wherein each of the two ground shaped faces begins at a position between the transverse center and a corresponding transverse edge of the drill bit cutter in the transverse direction.

9. The drill bit cutter according to claim 1, wherein the two ground shaped faces are configured such that the two blades each have an effective cutting portion that participates in drilling of a workpiece material and a non-cutting portion that does not participate in drilling of the workpiece material; or
one of the two blades has an effective cutting portion that participates in drilling of the workpiece material and a non-cutting portion that does not participate in drilling of the workpiece material, and the entirety of the other one is an effective cutting portion.

10. The drill bit cutter according to claim 1, wherein:
the two rear cutter faces are inclined at different angles relative to the transverse direction; and/or
a drill tip of the drill bit cutter deviates from the rotation axis in the transverse direction; and/or
the bisector of the angle between the two blades is inclined by an angle relative to the rotation axis.

11. A drill bit, comprising:
a drill shank; and
the drill bit cutter according to claim 1 which is mounted on the drill shank.
